(19) United States
(12) Patent Application Publication
(10) Pub. No.: US 2026/0230190 A1
(43) Pub. Date: Aug. 6, 2026

(54) ENTANGLEMENT OF ATOMS AND PHOTONS AT A TELECOM WAVELENGTH FOR QUANTUM NETWORKING

(71) Applicant: Wisconsin Alumni Research Foundation, Madison, WI (US)

(72) Inventor: Mark Saffman, Madison, WI (US)

(21) Appl. No.: 19/042,637

(22) Filed: Jan. 31, 2025

(51) Int. Cl. H04B 10/70

(52) U.S. Cl. CPC H04B 10/70

(57) ABSTRACT

A method for generating a time-bin encoded telecom wavelength photon is disclosed herein. The method includes preparing a superposition state in an atom in a trap, exciting, at a first time, to an excited state, where the excited state decays along a path to a decay state of the atom and the telecom wavelength photon, transforming the decay state, and exciting, at a second time t₂, to an excited state, where the excited state decays along a path to a decay state of the atom and the telecom wavelength photon.

### STATEMENT REGARDING FEDERALLY SPONSORED RESEARCH

This invention was made with government support under DE-AC02-06CH11357 awarded by the US Department of Energy and under 2016136 awarded by the National Science Foundation. The government has certain rights in the invention.

### FIELD OF THE INVENTION

The disclosed technology is generally directed to entanglement of atoms and photons. More particularly the technology is directed to entanglement of atoms and photons at a telecom wavelength for quantum networking.

### BACKGROUND OF THE INVENTION

Entanglement of Rb atoms with near infrared photons at 780 nm was demonstrated in 2006. For long distance transmission through optical fibers 780 nm is not well suited due to strong absorption. Optical fibers have much lower loss at longer telecom band wavelengths ranging from 1300-1600 nm. Entanglement of Rb atoms with telecom wavelengths has been achieved using two different techniques. One approach is to use a four-wave mixing scheme that generates a telecom wavelength photon from a transition between two different excited states. The reliance on four-wave mixing adds complexity since it requires two or three strong pump fields to mediate the nonlinear interaction. Another approach is to generate 780 nm photons and then convert them to a telecom wavelength using a nonlinear optical crystal. This approach also suffers from additional complexity for implementing the frequency conversion, added noise from the frequency conversion process, and suffers losses in the conversion process which is typically only about 50% efficient. What is needed are better ways to generate longer wavelengths in the telecom frequency.

### SUMMARY

Disclosed herein are methods for generating a time-bin encoded telecom wavelength photon or a polarization encoded telecom wavelength photon, entangling an atom and a photon, and systems for remote entanglement.

In one aspect according to the disclosure herein, the method for generating a time-bin encoded telecom wavelength photon includes (a) preparing a superposition state in an atom in a trap, where the superposition state is |ψ>=(|0>+|1>)/\sqrt{2}, (b) exciting, at a first time t₁, state |1> to an excited state |d>, where the excited state |d>decays along path |d>→|p>→|1> to a decay state of the atom and the telecom wavelength photon |Ψ>=(|0>+|1>|v>ₜ₁ |vₐ>ₜ₁)/\sqrt{2} and |v>ₜ₁ representing the telecom wavelength photon generated at time t₁ by the decay between states |d> and |p> and |vₐ>ₜ₁ representing an additional photon generated at time t₁, (c) transforming the decay state |Ψ>, wherein the transformed state is |Ψ>=(|0>|v>ₜ₁+|1>)/\sqrt{2}, and (d) exciting, at a second time t₂, state |1> to the excited state |d>, where the excited state |d> decays along path |d>→|p>→|1> to a decay state of the atom and the telecom wavelength photon |Ψ>=(|0>|v>ₜ₁+|1>|v>ₜ₂)/\sqrt{2} and |v>ₜ₂ representing the telecom wavelength photon generated at time t₂ by the decay between states |d> and |p>. In some embodiments, the atom is Rb. In some embodiments, the atom is ⁸⁷Rb and

$$\vert 0 >= \vert 5 {s}_{\frac{1}{2}} ,$$

f=1, m=1>,

$$\vert 1 >= \vert 5 {s}_{\frac{1}{2}} ,$$

f=2, m=2>,

$$\vert d >= \vert 4 {d}_{\frac{5}{2}} ,$$

f=4, m=4>, and

$$\vert p >= \vert 5 {p}_{\frac{3}{2}} ,$$

f=3, m=3>, or the atom is ⁸⁵Rb and

$$\vert 0 >= \vert 5 {s}_{\frac{1}{2}} ,$$

f=2, m=2>,

$$\vert 1 >= \vert 5 {s}_{\frac{1}{2}} ,$$

f=3, m=3>,

$$\vert d >= \vert 4 {d}_{\frac{5}{2}} ,$$

f=5, m=5>, and

$$\vert p >= \vert 5 {p}_{\frac{3}{2}} ,$$

f=4, m=4>, some embodiments, the telecom wavelength photon is a 1529 nm photon. In some embodiments, the atom is coupled to an optical resonator and the method further includes collecting and transmitting the time-bin encoded telecom wavelength photon along an optical transmission line.

In another aspect according to the disclosure herein, the method for generating a polarization encoded telecom wavelength photon includes (a) preparing a superposition state in an atom in a trap, where the superposition state is |v>=(|0>+|1>)/\sqrt{2}; (b) exciting state |1> to an excited state |d₁> and state |0> to an excited state |d₀>, where the excited state |d₁>decays along path |d₁>→|p1 >→|1> and the excited state |d₀>decays along path |d₀>>|p₀>→|0> to a decay state of the atom and the telecom wavelength photon |Ψ>=(|0>|σ₋>+|1>|σ₊>)/\sqrt{2} where |σ₋> and |σ₊>represent telecom wavelength photon generated by the decay between states |d₀> and |p₀> and |d₁> and |p₁>, respectively. In some embodiments, the atom is Rb. In some embodiments, the atom is ⁸⁷Rb and ⁸⁷Rb and

$$\vert 0 >= \vert 5 {s}_{\frac{1}{2}} ,$$

f=2, m=−2>,

$$\vert 1 >= \vert 5 {s}_{\frac{1}{2}} ,$$

f=2, m=2>,

$$\vert {d}_{0} >= \vert 4 {d}_{\frac{5}{2}} ,$$

f=4, m=−4>,

$$\vert {p}_{0} >= \vert 5 {p}_{\frac{3}{2}} ,$$

f=3, m=−3>,

$$\vert {d}_{1} >= \vert 4 {d}_{\frac{5}{2}} ,$$

f=4, m=4>, and

$$\vert {p}_{1} >= \vert 5 {p}_{\frac{3}{2}} ,$$

f=3, m=3>, or the atom is ⁸⁵Rb and

$$\vert 0 >= \vert 5 {s}_{\frac{1}{2}} ,$$

f=3, m=−3>,

$$\vert 1 >= \vert 5 {s}_{\frac{1}{2}} ,$$

f=3, m=3>,

$$\vert {d}_{0} >= \vert 4 {d}_{\frac{5}{2}} ,$$

f=5,m=−5>,

$$\vert {p}_{0} >= \vert 5 {p}_{\frac{3}{2}} ,$$

f=4, m=−4>,

$$\vert {d}_{1} >= \vert 4 {d}_{\frac{5}{2}} ,$$

f=5, m=5>, and

$$\vert {p}_{1} >= \vert 5 {p}_{\frac{3}{2}} ,$$

f=4, m=4>. In some embodiments, the telecom wavelength photon is a 1529 nm photon. In some embodiments, the atom is coupled to an optical resonator and the method further comprises collecting and transmitting the time-bin encoded telecom wavelength photon along an optical transmission line.

In another aspect according to the disclosure herein, the method for entangling an atom and a photon, the method includes (a) applying a first polarized light pulse to the atom in state |1 [symbol] to couple state |1 [symbol] to a first excited state (p [symbol] , (b) applying a polarized telecom wavelength photon have an opposite polarization to the first polarized light pulse to cause the transition of the first exited state |p [symbol] to a second excited state |d [symbol] , (c) applying a second polarized light pulse having the same polarization as the first polarized light pulse to couple the second excited state |d [symbol] to a ground state |0 [symbol] . In some embodiments, the atom is Rb. In some embodiments, the atom is ⁸⁷Rb and

$$\vert 0 >= \vert 5 {s}_{\frac{1}{2}} ,$$

f=1, m=1>,

$$\vert 1 >= \vert 5 {s}_{\frac{1}{2}} ,$$

f=2, m=2>,

$$\vert d >= \vert 4 {d}_{\frac{5}{2}} ,$$

f=4, m=4>, and

$$\vert p >= \vert 5 {p}_{\frac{3}{2}} ,$$

f=4, m=−4>, or where the atom is ⁸⁵Rb and

$$\vert 0 >= \vert 5 {s}_{\frac{1}{2}} ,$$

f=2, m=2>,

$$\vert 1 >= \vert 5 {s}_{\frac{1}{2}} ,$$

f=3, m=3>,

$$\vert d >= \vert 4 {d}_{\frac{5}{2}} ,$$

f=5, m=5>, and

$$\vert p >= \vert 5 {p}_{\frac{3}{2}} ,$$

f=4, m=4>. In some embodiments, the telecom wavelength photon is detuned from a resonant transition frequency to prevent spontaneously decay.

In another aspect according to the disclosure herein, the system for remote entanglement includes a first end station comprising a first matter qubit and a second end station including a second matter qubit, and a Bell measurement apparatus optically connected to the first end station and the second end station, where each of the first end station and second end station entangle the matter qubit and a telecom wavelength photon generated by the method according to claim 1, where the telecom wavelength photon is transmitted to the Bell measurement apparatus, and where the Bell measurement apparatus projects the first matter qubit at the first end station and the second matter qubit at the second end station into an entangled state. In some embodiments, the first end station and the second end station are optically connected by a chain of intermediate entanglement sources and Bell state measurement units.

In another aspect according to the disclosure herein, the system for remote entanglement includes a first end station comprising a first matter qubit and a second end station comprising a second matter qubit, and a Bell measurement apparatus optically connected to the first end station and the second end station, where each of the first end station and second end station entangle the matter qubit and a telecom wavelength photon generated according to the method disclosed herein, where the telecom wavelength photon is transmitted to the Bell measurement apparatus, and where the Bell measurement apparatus projects the first matter qubit at the first end station and the second matter qubit at the second end station into an entangled state. In some embodiments, the first end station and the second end station are optically connected by a chain of intermediate entanglement sources and Bell state measurement units.

In another aspect according to the disclosure herein, the system for remote entanglement includes a first end station comprising a first matter qubit, and a second end station comprising a second matter qubit, where the first end station is optically connected to the second end station, where the first matter qubit is entangled with a telecom photon generated according to the method disclosed herein, that is transmitted to coherently interact with the second matter qubit, and where the first matter qubit and second matter qubit become entangled.

In another aspect according to the disclosure herein, the system for remote entanglement includes a first end station comprising a first matter qubit, and a second end station comprising a second matter qubit, where the first end station is optically connected to the second end station, where the first matter qubit is entangled with a telecom photon, generated according to the method disclosed herein, that is transmitted to coherently interact with the second matter qubit, and where the first matter qubit and second matter qubit become entangled.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. A block diagram showing a system for remote entanglement of matter qubits A and B by entangling each of the matter qubits with a telecom wavelength photon and then making a Bell state measurement of the photons at an intermediate location, according to an aspect of the disclosure herein.

FIG. 2. A block diagram showing a system for remote entanglement of matter qubits A and B mediated by a quantum repeater chain, according to an aspect of the disclosure herein. The components are Rb atom matter qubits at each end, NFC=nonlinear frequency conversion unit, BM=Bell state measurement unit, Si qubit=Si T center qubit. The example shown has three intermediate BM stages, although more can be added for longer links.

FIG. 3. A block diagram showing a system for remote entanglement of matter qubits A and B by entangling matter qubit A with a telecom wavelength photon and then transmitting the telecom wavelength photon to matter qubit B, according to an aspect of the disclosure herein. At location B the telecom wavelength photon interacts with the matter qubit in a way that transfers a quantum state from A to B, or prepares entanglement of the matter qubits A and B.

FIG. 4. A flow chart showing the steps of a method for entangling qubits with telecom wavelength photons.

FIG. 5. Energy level scheme for generation of a 1529 nm photon via excitation and subsequent decay of the 4d_{5/2} level to the 5p_{3/2} level.

FIG. 6. Stimulated Raman energy level scheme for absorption of a 1529 nm photon that maps |1 [symbol] to |0 [symbol] .

FIG. 7A. A flow chart showing the steps of a method for entangling qubits with telecom wavelength photons in the polarization basis.

FIG. 7B. Energy level scheme showing the protocol for generation of atom-photon entanglement in the polarization basis.

### DETAILED DESCRIPTION OF THE INVENTION

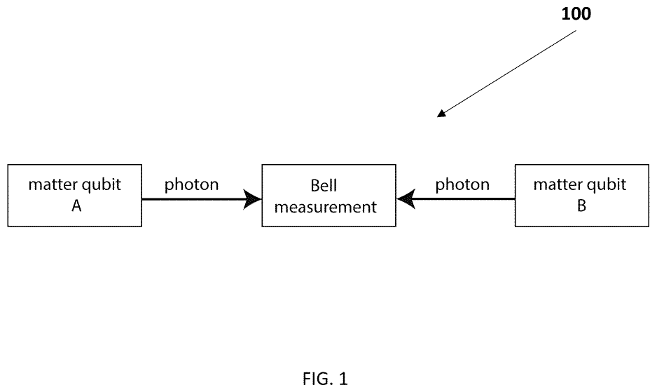

Disclosed herein is a new approach that directly generates telecom wavelength photons in Rb atoms, without requiring external frequency conversion. This new approach only requires one additional laser wavelength as compared to the existing methods for generating 780 nm photons. The disclosed system and method can also be used to generate time-bin encoded photons which have not been demonstrated previously with atomic emitters, and only recently with trapped ions. A system 100 for entangling matter qubits with telecom wavelength photons is shown in FIG. 1. The system 100 can include a first end station and a second end station and a Bell measurement apparatus optically connected to the first end station and the second end station. The first end station and second end station can each include a trap to hold the matter qubits. For example, the trap can be an optical trap. The optical trap can be in free space or inside an optical resonator. The optical resonator can be positioned adjacent to a lens or mirror that couples the telecom wavelength photon to an optical fiber. The optical resonator can be an optical cavity that is resonant at the wavelength of the telecom wavelength photon. The trap may also be a magnetic trap of atoms. The first end station and second end station can each further include lasers and optical components such as mirrors and lenses and components to control the polarization state of the photons as well as components to couple the photons into optical fibers. The optical connection can be an optical fiber.

The first end station is configured to prepare a first matter qubit entangled with a first telecom wavelength photon. The second end station is configured to prepare a second matter qubit entangled with a second telecom wavelength photon. Each of the first and second telecom wavelength photons are transmitted to the Bell measurement apparatus via the optical connection.

The Bell measurement apparatus can project the first matter qubit at the first end station and the second matter qubit at the second end station into an entangled state with a success probability of 10%, 20%, 30%, 40%, 45%, 49% or 50%. The success probability is at most 50% but can be lower due to imperfect matching of the photons, optical losses on components and finite efficiency of the photon detectors in the Bell measurement apparatus.

The first and second telecom wavelength photons can each be 1529 nm photons. The first and second matter qubits can each be a rubidium (Rb) atom. The Rb atoms can be stationary. In some cases, motion of the Rb atom is suppressed using laser cooling techniques.

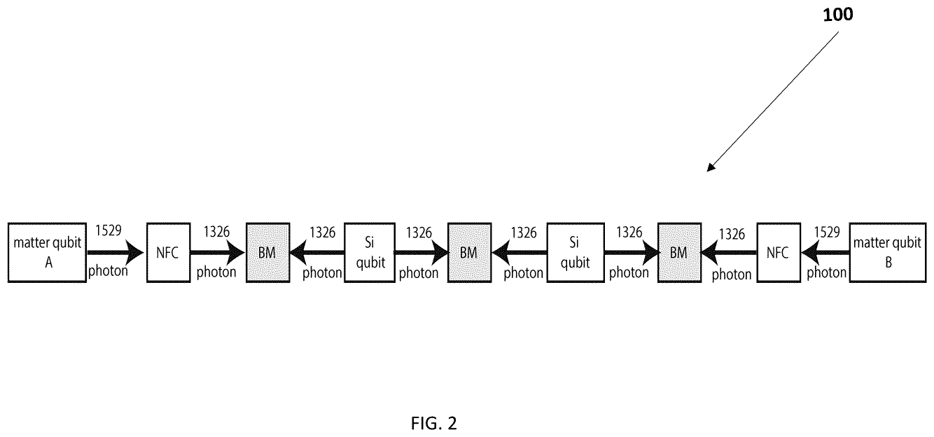

FIG. 2 shows an example of system 100 where remote entanglement between a first matter qubit and a second matter qubit is mediated by a quantum repeater chain. The system 100 includes the first and second matter qubits at each end optically connected by a chain of intermediate entanglement sources, nonlinear frequency conversion units (NFC) and Bell state measurement units (BM). The intermediate entanglement sources can include Rb atoms or solid-state silicon having defects such as T centers, or other solid state sources of photons such as quantum dots in III-V semiconductors. Each of the Bell state measurement units is optically connected to at least one intermediate entanglement source.

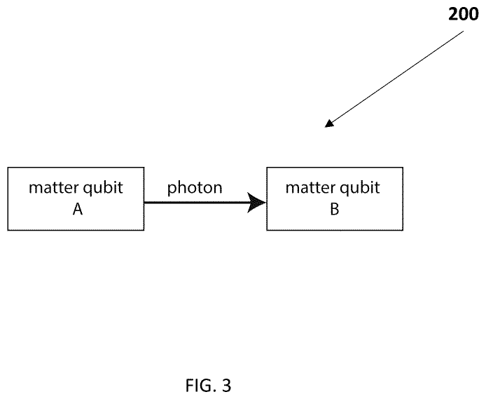

A system 200 for entangling qubits encoded in Rb atoms with telecom wavelength photons without a Bell measurement apparatus is shown in FIG. 3. In system 200, the first end station can include a first matter qubit and the second end station can include a second matter qubit. The first end station is optically connected to the second end station. In system 200, the first matter qubit is entangled with a telecom wavelength photon that is transmitted via the optical connection to coherently interact with the second matter qubit. The first matter qubit and second matter qubit thereby become entangled.

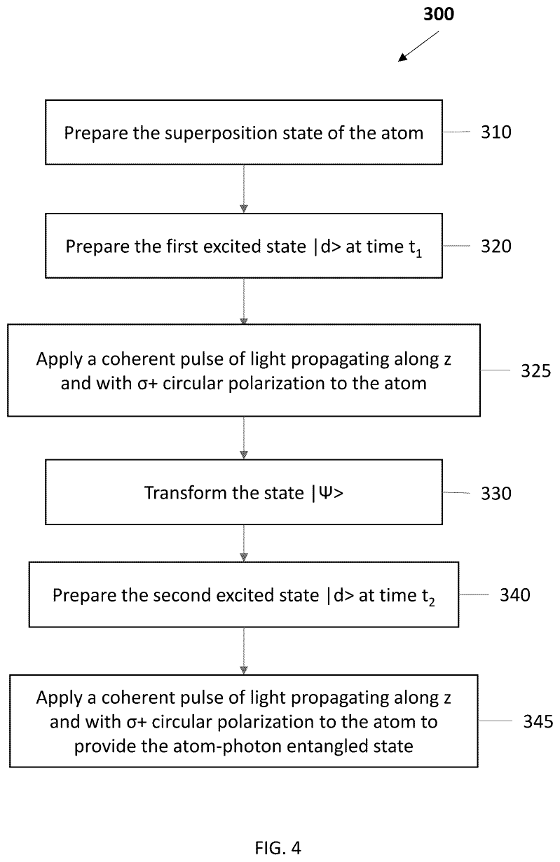

A method 300 for entangling qubits encoded in Rubidium (Rb) atoms with telecom wavelength photons is shown in FIG. 4. The method 100 can include atom-photon entangling with time bin encoding (FIG. 1). At 310, a superposition state of states |0 [symbol] and |1 [symbol] can be prepared by trapping a single atom in a trap, for example an optical trap. In some examples, the state |1 [symbol] can be prepared by optical pumping and applying a π/2 pulse using a microwave field at 6.8 GHz or optical Raman light to couple the |1 [symbol] and |0 [symbol] states.

At 320, state |1>can be excited at a first time t₁, to an excited state |d>. Subsequently, the excited state |d>decays along path |d>→|p>→|1> to a decay state of the atom and a telecom wavelength photon |Ψ>=(|0>+|1>|v>ₜ₁ |vₐ>ₜ₁)/\sqrt{2} where |v>ₜ₁ represents the telecom wavelength photon generated at time t₁ by the decay between states |d> and |p> and |vₐ>ₜ₁ represents the additional photon generated at time t₁. The telecom wavelength photon can be a 1529 nm photon. Additional photons can be released, for example, a 780 nm photon can be released as the excited state |d>decays.

An intermediate state, |Ψ>=(|0>+|1>|v>ₜ₁)/\sqrt{2}, can be generated at 325 where correlation to the additional photons, e.g., the 780 nm photon, has been removed. The correlation to the additional photons can be removed by applying to the atom a coherent pulse of light propagating along z and with σ₊ circular polarization to stimulate the decay from |p [symbol] back to |1 [symbol] . The wavelength of the light pulse can be the same as the wavelength of the additional photons. For example, Stimulated Rapid Adiabatic Transfer (STIRAP) can time the light pulse to appear before the emission of the telecom wavelength photon which prevents spontaneous emission from |p>back to |1>.

At 330, the intermediate state can be transformed, where the transformed state is |Ψ>=|0>|v>ₜ₁+|1>)/\sqrt{2}. For example, the decay state can be |Ψ>=(|0>+|1>|v₁₅₂₉>ₜ₁ |v₇₈₀>ₜ₁)/\sqrt{2}. Transformation can include a x pulse that is applied to the atom in the intermediate state which transforms the state to |Ψ>=(|0>|v>ₜ₁+|1>)/\sqrt{2}. The π pulse can be applied for example using a 6.8 GHz microwave or optical Raman light consisting of two optical fields with a frequency difference of 6.8 GHz.

At 340, state |1>can be excited at a second time t₂ to a second excited state |d>. Subsequently, the second excited state |d>decays along path |d>→|p →>|1> to a decay state of the atom. A second telecom wavelength photon |v>ₜ₂, is generated at time t₂ by the decay between states |d> and |p>. At 345 similar to 325, the correlation to the additional photons can again be removed by applying to the atom a coherent pulse of light, resulting in the atom-photon entangled state. The atom-photon entangled state in time-bin encoding is |Ψ>=(|0>|v>ₜ₁+|1>|v>ₜ₂)/\sqrt{2}.

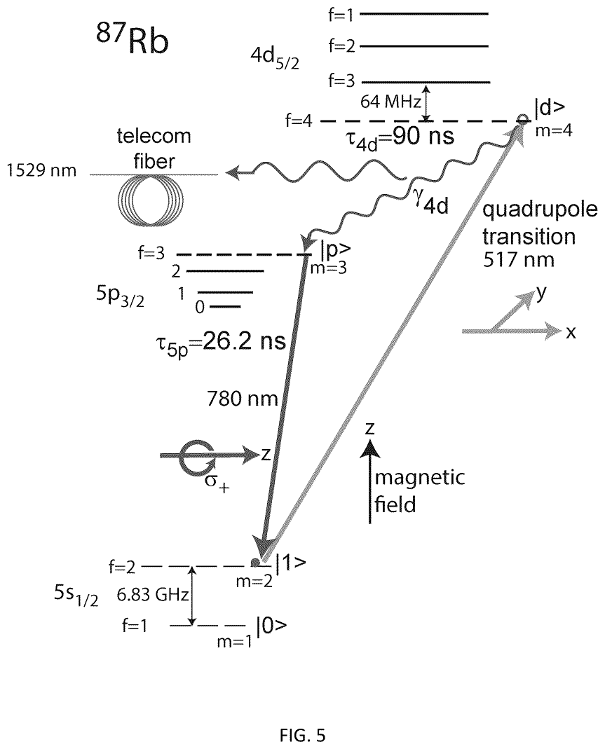

An example of the excitation and emission scheme for Rb is shown in FIG. 5. The atom can be ⁸⁷Rb, where

$$\vert 0 >= \vert 5 {s}_{\frac{1}{2}} ,$$

f=1, m=1>,

$$\vert 1 >= \vert 5 {s}_{\frac{1}{2}} ,$$

f=2, m=2>,

$$\vert d >= \vert 4 {d}_{\frac{5}{2}} ,$$

f=4,m=4>, and

$$\vert p >= \vert 5 {p}_{\frac{3}{2}} ,$$

f=3, m=3>. In another example, the atom can be ⁸⁵Rb, where

$$\vert 0 >= \vert 5 {s}_{\frac{1}{2}} ,$$

f=2, m=2>,

$$\vert 1 >= \vert 5 {s}_{\frac{1}{2}} ,$$

f=3, m=3>,

$$\vert d >= \vert 4 {d}_{\frac{5}{2}} ,$$

f=5, m=5>, and

$$\vert p >= \vert 5 {p}_{\frac{3}{2}} ,$$

f=4, m=4>.

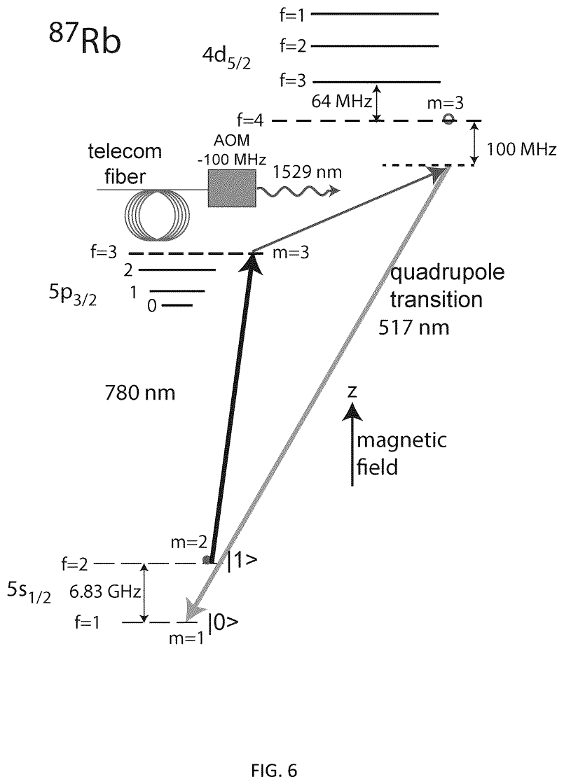

Additionally, and alternatively, remote entanglement can be accomplished as shown in FIG. 6. This can be done via a stimulated Raman transition and is effectively the reverse of method 300. In a first step, a first polarized light pulse, e.g., σ⁺ polarized light, is applied to an atom in state |1 [symbol] to couple state |1 [symbol] to first exited state |p [symbol] . An incident polarized telecom wavelength photon opposite to the first polarized light pulse, e.g., o-polarized light, is applied to cause the transition of the first excited state |p [symbol] to a second excited state |d [symbol] . A second polarized light pulse having the same polarization as the first polarized light pulse is applied to couple the second excited state |d [symbol] to ground state |0 [symbol] . The telecom wavelength photon can be detuned from the excited state |d> to prevent spontaneous population decay.

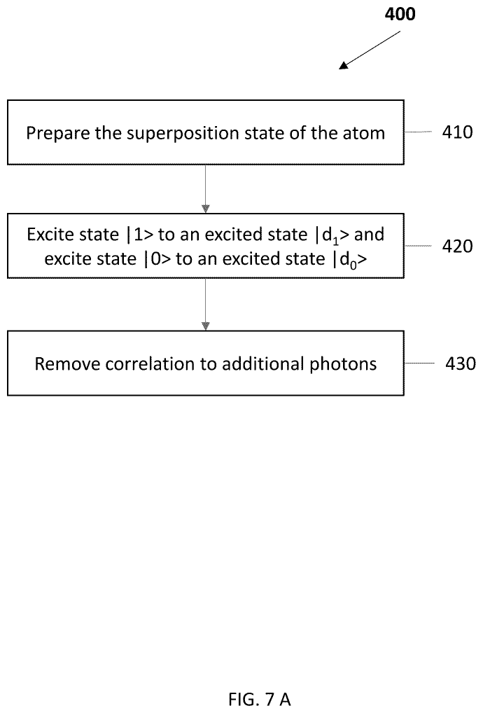

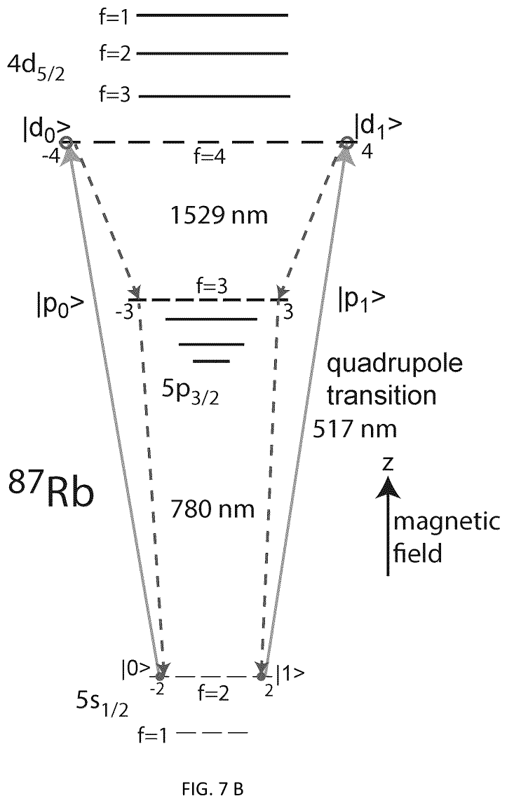

Additionally, and alternatively, remote entanglement can be accomplished according to method 400 as shown in FIG. 7A. The method 400 includes preparing a superposition state in an atom in a trap at 410, where the superposition state is |Ψ>=(|0>+|1>)/\sqrt{2}. The superposition state can be excited at 420 such that state |1> is excited to an excited state |d₁> and state |0> is excited to an excited state |d₀>. The excited state |d₁>decays along path |d₁>→|p₁>→|1> and the excited state |d₀>decays along path |d₀>→|p₀>→|0>. These decay paths lead to a decay state of the atom and the telecom wavelength photon |Ψ>=(|0>|σ₋>+|1>|σ₊>)/\sqrt{2} where |σ₋> and |σ₊>represent telecom wavelength photons generated by the decay between states |d₀> and |p₀> and |d₁> and |p₁>, respectively. As described for method 300, an intermediate state can be generated at 430 where correlation to the additional photons, e.g., the 780 nm photon, has been removed from the decay state to form the entangled state of the atom and the telecom wavelength photon. FIG. 7B shows an energy level scheme showing the protocol for generation of atom-photon entanglement in the polarization basis for ⁸⁷Rb.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Examples

A system and method for entangling qubits encoded in Rubidium (Rb) atoms with telecom wavelength photons are provided. The method utilizes atomic transitions that enable direct generation of photons in the telecom region near 1500 nm wavelength. The method allows for entanglement involving the polarization state of the optical photon or the time of the optical photon in so-called “time-bin” encoding. Entanglement using telecom wavelength photons is suitable for low loss transmission through optical fibers which is important for long distance quantum communication. The generated entanglement can be used to establish remote atom-atom entanglement based on known and established techniques of entanglement swapping or direct state transfer. The remote entanglement can then be used for quantum communication protocols, distributed quantum computation, and distributed quantum sensing.

A block diagram of a system for remote entanglement based on Bell state measurements is shown in FIG. 1. In this system the two end stations prepare entanglement between a stationary matter qubit that serves as a quantum memory and a flying photon that is transmitted towards the Bell measurement apparatus. The Bell measurement apparatus interferes the photons from each end station followed by measurement with photon counting detectors, following well established techniques. In the ideal case of indistinguishable photons, no noise, no excess optical losses, and 100% efficiency photon detectors the Bell measurement apparatus will succeed in making a quantum measurement that projects the matter qubits at the two end stations into an entangled state with a success probability of 50%. It can be shown that using linear optics to interfere the photons and perfect detectors a 50% success rate is the best that can be achieved. Once the matter qubits at the end stations are entangled they can be used as a resource to teleport quantum states and quantum operations from one end station to the other which enables distributed quantum computing and distributed quantum sensing.

An alternative implementation that can in principle surpass the 50% success rate based on Bell state measurements is shown in FIG. 3. In this implementation the matter qubit at station A is entangled with a flying photon that is transmitted to station B. At station B the incident photon is coupled to a matter qubit with a procedure that swaps the entanglement between matter qubit A and the photon with entanglement between matter qubits A and B. This method of transferring quantum states or of generating remote entanglement has been demonstrated. Although conceptually simpler than the approach shown in FIG. 1 this direct transfer method is technically more challenging to implement and has not been as widely employed. The technical challenge arises from the requirement of a coherent interaction between the photon incident at location B and the matter qubit, whereas in the method of FIG. 1 the photons are detected by the Bell measurement device but do not need to interact with another quantum object.

For the methods shown in FIG. 1 or 3 the distance between the matter qubit locations is limited by optical losses. When the photons are transmitted though optical fibers such losses are minimized by using photon wavelengths in telecom bands that stretch from 1300-1600 nm. These are the so-called telecom O-,E-,S-,C- and L-bands. For many matter qubits, including alkali atoms, the wavelengths that are most convenient for generating qubit-photon entanglement are in the near infrared region with 2<1000 nm. These wavelengths are strongly attenuated under transmission in optical fibers. To circumvent this issue the near infrared wavelengths can be converted to telecom bands using frequency conversion in nonlinear optical media. However, such nonlinear frequency conversion introduces additional noise and loss mechanisms. The methods and systems disclosed herein show how telecom band photons can be directly generated in Rb atoms without requiring additional frequency conversion steps.

### Time-Bin Encoding

An exemplary atomic level scheme for generation of entanglement is shown in FIG. 5. Generation of atom-photon entanglement with time bin encoding involves the following steps.

The atom is prepared in a superposition stately |ψ>=(|0>+|1>)/\sqrt{2} where

$$\vert 0 >= \vert 5 {s}_{\frac{1}{2}} ,$$

f=1,m=1> and

$$\vert 1 >= \vert 5 {s}_{\frac{1}{2}} ,$$

f=2,m=2>. The state is prepared using standard techniques comprising trapping a single atom in an optical (or other type) of trap, using optical pumping to prepare the state |1) and then applying a π/2 pulse using a microwave field at 6.8 GHz or optical Raman light that couples the |1 [symbol] and |0 [symbol] states.

At time t₁ the state |1 [symbol] is excited from |1 [symbol] →|d [symbol] where

$$\vert d >= \vert 4 {d}_{\frac{5}{2}} ,$$

f=4, m=4>. This is done using 517 nm light propagating along the x axis and polarized along y, where the z axis is the quantization axis. Quantum selection rules for atomic transitions as applied to this geometry lead to coupling of |1 [symbol] to the excited state |d [symbol] and the states

$$\vert 4 {d}_{\frac{5}{2}} ,$$

f=4, m=f> and

$$\vert 4 {d}_{\frac{5}{2}} ,$$

f=4, m=4>. Coupling to the latter two states can be suppressed by applying a small magnetic field along z to lift the degeneracy of the Zeeman sublevels. In this way state |1 [symbol] is resonantly excited to state |d [symbol] while the other 4d_{5/2} states are not resonant with the excitation laser. State |0 [symbol] is not excited due to the 6.8 GHzenergy difference.

The excited atom will then decay along the path |d [symbol] →|p [symbol] →|1 [symbol] with |p [symbol] =|5p_{3/2}, f=3, m=3>while emitting a 1529 nm photon and a 780 nm photon. Due to atomic selection rules no other decay path is possible. Direct decay back to |1) while emitting a 517 nm photon is strongly suppressed since |1>< >|d) is a quadrupole transition which is much weaker than the dipole allowed decay via 5p_{3/2}.

After the decay the state of the atom and the 1529 and 780 nm photons is

$$\vert Ψ 〉 = \frac{{{\vert 0 〉 + \vert 1 〉 \vert {v}_{1529} 〉}_{{t}_{1}} \vert {v}_{780} 〉}_{{t}_{1}}}{\sqrt{2}} \qquad ( 1 )$$

where |v₁₅₂₉ [symbol] ₜ₁, |v₇₈₀)ₜ₁ represent the 1529 and 780 nm photons emitted at time t₁. This state is not immediately suitable for remote entanglement due to the unwanted correlation with the 780 nm photon which is emitted in a random direction. In order to remove this correlation a coherent pulse of 780 nm light propagating along z and with 0+circular polarization is applied to the atom to stimulate the decay from |p) back to |1). Using known methods of Stimulated Rapid Adiabatic Transfer (STIRAP) which involve timing the 780 nm pulse to appear before the emission of the 1529 nm photon is completed population of state |p [symbol] is suppressed which prevents spontaneous emission from |p). Since the 780 nm pulse will contain 10¹⁵ or more photons the addition of a single 780 nm photon will not bedetectable and will not degrade the atom-photon entanglement.

Using this technique we prepare the state

$$\vert Ψ 〉 = \frac{{\vert 0 〉 + \vert 1 〉 \vert {v}_{1529} 〉}_{{t}_{1}}}{\sqrt{2}} . \qquad ( 2 )$$

A π pulse using either a 6.8 GHz microwave or optical Raman light consisting of two optical fields with a frequency difference of 6.8 GHz is then applied to the atom which transforms the state to

$$\vert Ψ 〉 = \frac{{\vert 0 〉 \vert {v}_{1529} 〉}_{{t}_{1}} + \vert 1 〉}{\sqrt{2}} .$$

The excitation step may be repeated at time t₂ leading to the final state

$$\vert Ψ 〉 = \frac{{{\vert 0 〉 \vert {v}_{1529} 〉}_{{t}_{1}} + \vert 1 〉 \vert {v}_{1529} 〉}_{{t}_{2}}}{\sqrt{2}} . \qquad ( 1 )$$

This is an atom-photon entangled state in the so-called time-bin encoding where the emission time of the photon is entangled with the quantum state of the atom. A requirement for distinguishability of the early (t₁) and late (t₂) photons is (t₂−t₁)Δω>1 where Δω is the uncertainty in the frequency of the emitted 1529 nm photon. The frequency uncertainty is Δω ~1/τ_{4d}=1/(90 ns). We therefore require t₂−t₁>90 ns which implies a photon generation rate of at most r~5 MHz. As we will see below this estimate is overly optimistic due to the need to suppress undesired entanglement with the motional state of the atom.

FIG. 5 shows the relevant atomic states for the ⁸⁷Rb atom. It is also possible to use the ⁸⁵Rb isotope. In this case the protocol is essentially the same except the relevant states are

$$\vert 0 〉 = \vert 5 {s}_{1 / 2} , f = 2 , m = 2 > ,$$

$$\vert 1 〉 = \vert 5 {s}_{1 / 2} , f = 3 , m = 3 > ,$$

$$\vert d 〉 = \vert 4 {d}_{5 / 2} , f = 5 , m = 5 > , and$$

$$\vert p 〉 = \vert 5 {p}_{3 / 2} , f = 4 , m = 4 > .$$

In a realization of this approach the atom may be trapped in front of a lens or mirror that couples the emitted photon into an optical fiber. The probability of collecting the emitted photon and coupling it into a fiber depends on the numerical aperture of the collection optic. It is also possible to place the atom in an optical cavity that is resonant at the wavelength of the emitted photon. In this way the collection efficiency can be enhanced by an order of magnitude or more, depending on the cavity parameters.

If two atoms in spatially separated locations are each entangled with a photon using the method described above, entanglement between the atoms can be achieved by making a measurement of the photons in the Bell basis leading to entanglement swapping, and preparation of entanglement between the atoms, as is depicted in FIG. 1. Such entanglement swapping can succeed with a probability of at most 50%.

The alternative protocol for remote entanglement shown in FIG. 3 can be implemented by mapping the emitted 1529 nm photon onto an atomic state. This can be done via a stimulated Raman transition which amounts to reversing the emission sequence as shown in FIG. 6. The receiver atom is prepared in state |1 [symbol] . If a 1529 nm photon is present at the time at which the 780 and 517 nm mapping lasers are turned on the atom will be transferred to state |0 [symbol] . If a photon is not present the atom will stay in state |1 [symbol] .

To implement this a strong 780 nm beam that is σ⁺ polarized couples |1 [symbol] →|5p_{3/2}, f=3, m=3>. All decay from this state returns to |1) due to atomic selection rules and is not lost. The incident 1529 nm photon is set to o-polarization and drives the transition |5p_{3/2}, f=3, m=3 >→|4d_{5/2}, f=2, m=2>, but may be detuned by 100 MHz using an acousto-optic modulator (AOM) frequency shifter on the incoming photon. The shift prevents populating the 4d_{5/2}, f=2, 3, 4 states which would be subject to spontaneous decay. The value of 100 MHz is not critical and can be chosen to optimize transition efficiency while minimizing unwanted spontaneous scattering. A strong 517 nm drive completes the stimulated Raman process and has a frequency that is resonant with the transition to |5s_{1/2}, f=1, m=1>. The 517 nm light propagates along z and has σ⁺polarization. The 517 nm light drives a Δm=−1 transition which couples |4d_{5/2}, f=2, m=2> to the state |0 [symbol] . Note that the state |4d_{5/2}, f=4, m=2> is not coupled to |0) since it involves a transition with Δf=−3 which is forbidden for quadrupole transitions.

High fidelity direct generation of time-bin entanglement requires that undesired entanglement of the atomic spin-state with the center of mass motion of the trapped atom is suppressed. In order to do this the time between photon emissions, τ=t₂−t₁ should be a multiple of the motional vibration period of the atom. For an optical trap created by focusing a single beam to a circular Gaussian spot with waist (1/e² intensity radius) ω the radial and axial vibration frequencies are

$${ω}_{radial} = \frac{2}{w} \sqrt{U / m}$$

$${ω}_{axial} = \frac{\sqrt{2} λ}{π {w}^{2}} \sqrt{U / m}$$

where λ is the wavelength of the trapping light, U is the depth of the optical trap in energy units, and m is the atomic mass. The ratio of the radial and axial frequencies is

$$\frac{{ω}_{radial}}{{ω}_{axial}} = \frac{\sqrt{2} π w}{λ} .$$

The condition for the ratio to be an integer, which allows for simultaneous cancellation of motional entanglement with respect to both radial and axial degrees of freedom, is

$${w}_{n} = n \frac{λ}{\sqrt{2} π} \qquad ( 3 )$$

with n an integer. As an example, taking λ=1064 nm which is a convenient trap wavelength for which high power lasers are available, the values of n=3, 4 give ω₃=719 nm, ω₄=958 nm, ω₅=1198 nm. Setting ω=ωₙ the gap time is

$$τ = \frac{2 π}{{ω}_{axial}} .$$

Typical optical traps as used in neutral atom quantum computing and networking experiments have ωₐₓᵢₐₗ~2π×10-30 kHz which implies a maximal atom-photon entanglement generation rate of

$$r = \frac{1}{τ} ∼ 10 , 000 - 30 , 000 {s}^{- 1} .$$

For some quantum network applications this rate is inadequate. The rate can be substantially increased by adding additional light fields to increase the axial trap frequency. For example by superimposing a standing wave along the axial direction of the trap the axial frequency can be boosted to be several times larger than the radial frequency. Doing so will yield an improved entanglement generation rate of

$${r}^{′} = \frac{{ω}_{radial}}{2 π} .$$

This rate can be up to r′~150,000 s⁻¹ with readily accessible trap parameters.

### Polarization Encoding

As described above we may generate time-bin entanglement at 1529 nm. It is possible to convert from time-bin entanglement to a polarization basis entanglement with an unbalanced optical interferometer following well known techniques. It is also possible to directly generate atom-photon entanglement with the photon encoded in a polarization basis using the modified scheme shown in FIGS. 7A and 7B. Polarization basis entanglement involves a single atomic excitation pulse and does not impose timing requirements to suppress strong motional entanglement, as is the case for the time-bin approach. For long distance transmission the polarization basis entanglement can then be converted to a time-bin basis using an unbalanced interferometer.

The protocol for preparing entanglement in the polarization basis is shown in FIG. 7B. The involved states are

$$\vert 0 >= \vert 5 {s}_{\frac{1}{2}} , f = 2 , m = - 2 > ,$$

$$\vert 1 >= \vert 5 {s}_{\frac{1}{2}} , f = 2 , m = 2 > ,$$

$$\vert {d}_{0} > = \vert 4 {d}_{\frac{5}{2}} , f = 4 , m = - 4 > ,$$

$$\vert {p}_{0} > = \vert 5 {p}_{\frac{3}{2}} , f = 3 , m = - 3 > ,$$

$$\vert {d}_{1} > = \vert 4 {d}_{\frac{5}{2}} , f = 4 , m = 4 > , and$$

$$\vert {p}_{1} > = \vert 5 {p}_{\frac{3}{2}} , f = 3 , m = 3 >$$

Generation of atom-photon entanglement with polarization basis encoding involves the following steps:

The atom is prepared in a superposition state |ψ [symbol] =(|0)+|1 [symbol] )/\sqrt{2}. The state is prepared by first pumping the atom into |1) and then applying a π/2 pulse with microwaves or Raman light to prepare (|1 [symbol] +|1′> [symbol] /\sqrt{2} where |1′ [symbol] =5s_{1/2}, f=1, m=1. A sequence of three π pulses then transfers |1′ [symbol] >→5s_{1/2},f=2,m=0→5s_{1/2},f=1, m=−1→5s_{1/2},f=2, m=−2. In this way the superposition state |ψ [symbol] =(|0 [symbol] +|1 [symbol] )/\sqrt{2} can be prepared.

The state |1 [symbol] is excited from |1 [symbol] →|d₁ [symbol] and the state |0 [symbol] is excited from |0 [symbol] →|d₀ [symbol] . This is done using 517 nm light propagating along the x axis and polarized along y, where the z axis is the quantization axis. Quantum selection rules for atomic transitions as applied to this geometry lead to coupling of |1 [symbol] to the excited state |d₁ [symbol] and the states |4d_{5/2}, f=4, m=0>, |4d_{5/2}, f=4, m=2>. Coupling to the latter two states can be suppressed by applying a small magnetic field along z to lift the degeneracy of the Zeeman sublevels. In this way state |1 [symbol] is resonantly excited to state |d₁ [symbol] while the other 4d_{5/2} states are not resonant with the excitation laser. In a similar fashion |0) is coupled to the excited states |d₀ [symbol] and |4d_{5/2}, f=4, m=−2 >, |4d_{5/2}, f=4, m=0>. The unwanted transitions are suppressed due to the applied magnetic field. In order to transfer |0 [symbol] →|d₀ [symbol] and |1 [symbol] →|d₁ [symbol] two frequencies of 517 nm light are supplied, with one frequency resonant with |0 [symbol] →|d₀ [symbol] and one frequency resonant with |1 [symbol] →|d₁ [symbol] .

An excited atom will then decay along the paths |d₀ [symbol] →|p₀ [symbol] →|0 [symbol] and |d₁ [symbol] →|p₁ [symbol] →|1 [symbol] while emitting a 1529 nm photon and a 780 nm photon. The decay of |d₀ [symbol] results in σ⁻ polarized photons and the decay of |d₁) results in σ⁺ polarized photons. Due to atomic selection rules no other decay paths are possible. Direct decay back to the 5s_{1/2} level while emitting a 517 nm photon is strongly suppressed since the quadrupole transition is much weaker than the dipole allowed decay via 5p_{3/2}.

As was discussed in connection with FIG. 5 for preparation of time-bin entanglement the emitted 780 nm photons lead to undesired correlations. These correlations can be erased using stimulated transfer back to the 5s_{1/2} ground states using coherent pulses of σ⁺ and o-polarized 780 nm light and Stimulated Rapid Adiabatic Transfer as described above.

After the decay the state of the atom and the 1529 nm photon is

$$\vert Ψ 〉 = \frac{\vert 0 〉 \vert {σ}_{-} 〉 + \vert 1 〉 \vert {σ}_{+} 〉}{√ 2}$$

where |σ₊ [symbol] represents the 1529 nm photon and polarization state. This is an entangled atom-photon state in the polarization basis.

FIG. 7B shows the relevant atomic states for the ⁸⁷Rb atom. It is also possible to use the ⁸⁵Rb isotope. In this case the protocol is essentially the same except the relevant states are

$$\vert 0 > = \vert 5 {s}_{\frac{1}{2}} , f = 3 , m = - 3 > ,$$

$$\vert 1 >= \vert 5 {s}_{\frac{1}{2}} , f = 3 , m = 3 > ,$$

$$\vert {d}_{0} > = \vert 4 {d}_{\frac{5}{2}} , f = 5 , m = - 5 > ,$$

$$\vert {p}_{0} > = \vert 5 {p}_{\frac{3}{2}} , f = 4 , m = - 4 > ,$$

$$\vert {d}_{1} > = \vert 4 {d}_{\frac{5}{2}} , f = 5 , m = 5 > , and$$

$$\vert {p}_{1} > = \vert 5 {p}_{\frac{3}{2}} , f = 4 , m = 4 >$$

We note that after each cycle of steps, the atom remains in an equal superposition of |0 [symbol] and |1 [symbol] . However, measurement of the emitted photon by a photodetector or absorption of the photon in an optical element results in collapse of the atomic superposition to either the |0 [symbol] or |1 [symbol] state. Thus the step that prepares the superposition state |ψ [symbol] has to be repeated upon each attempt at generating atom-photon entanglement.

With this in mind the rate at which atom-photon entanglement can be attempted is governed by the time for the 517 nm excitation pulse, the time for the atom to decay back to the ground state, the time for a photon measurement, and the time to prepare the initial superposition state for the next attempt. We may estimate this time as 2 μs for the 517 nm pulse, 4×τ_{4d}+τ₅ₚ~0.5 μs for the atomic decay, 1 μs for the photon measurement, and, 15 μs for optical pumping and preparing the superposition state. This leads to a maximum attempt rate of 1/(18.5 μs) ~50,000 s⁻¹.

### Hybrid Entanglement for Quantum Repeaters

Even with the use of telecom band photons the exponential absorption in optical fiber limits the maximum distance between matter qubits that is practically feasible without suffering vanishingly small success rates. This limitation can be improved on by the use of quantum repeater architectures. The concept is shown in FIG. 2. A chain of intermediate matter qubit to photon entanglement sources and Bell state measurement units is used to connect the end stations. By repeated steps of Bell state measurement and entanglement swapping the qubits at the ends can be entangled with a rate that is greater than that which is possible with only a single intermediate Bell state measurement.

The intermediate qubit and photon sources could be the same Rb atoms as at the end stations. In order to maximize the reliability of the intermediate qubits and sources across a long chain it may be desirable to use a solid state implementation. The example shown is based on Si T centers which emit photons at a wavelength of 1326 nm. The 1529 nm photons emitted by Rb atoms can be converted to 1326 nm photons by difference frequency generation in a nonlinear crystal with quadratic nonlinearity using pump light at 710 nm wavelength. The success probability of the Bell state measurement relies on the photons having the same wavelength and also having the same temporal mode shape. The 1529 nm photons are emitted from an excited 4d_{5/2} state with lifetime of approximately 90 ns. The excited state lifetime of the Si T center is about 940 ns which would lead to poor temporal overlap. Purcell enhancement of the decay rate of Si T centers in an optical cavity leads to a lifetime of τₛᵢ≅65 ns. Using an exponential waveform for the emitted photon of

$${A}_{Si} = \sqrt{1 / {τ}_{Si}} {e}^{- t / ( 2 {τ}_{Si} )} ,$$

and the corresponding

$${A}_{Rb} = \sqrt{1 / {τ}_{Rb}} {e}^{- t / ( 2 {τ}_{Rb} )}$$

with τ_{Rb}=90 ns for the 1529 nm photon emitted from a Rb atom we find a temporal overlap of

$$O = {\int }_{0}^{∞} dt {A}_{Si} {A}_{Rb} = 2 \frac{{τ}_{Si} {τ}_{Rb}}{{τ}_{Si} + {τ}_{Rb}} = 0.987 .$$

Thus the temporal mode mismatch only incurs about 1% reduction in the success probability of the Bell state measurement.

1. A method for generating a time-bin encoded telecom wavelength photon, the method comprising:
(a) preparing a superposition state in an atom in a trap, wherein the superposition state is |ψ>=(|0>+|1>)/\sqrt{2};
(b) exciting, at a first time t₁, state |1> to an excited state |d>, wherein the excited state |d> decays along path |d>→|p>→|1> to a decay state of the atom and the telecom wavelength photon |Ψ>=(|0>+|1>|v>ₜ₁|vₐ>ₜ₁)/\sqrt{2} and |v>ₜ₁ representing the telecom wavelength photon generated at time t₁ by the decay between states |d> and |p> and |vₐ>ₜ₁ representing an additional photon generated at time t₁;
(c) transforming the decay state |Ψ>, wherein the transformed state is |Ψ>=(|0>|v>ₜ₁+|1>)/\sqrt{2}; and
(d) exciting, at a second time t₂, state |1> to the excited state |d>, wherein the excited state |d>decays along path |d>→|p>→|1> to a decay state of the atom and the telecom wavelength photon |Ψ>=(|0>+|v>ₜ₁+|1>|v>ₜ₂)/\sqrt{2} and |v >ₜ₂ representing the telecom wavelength photon generated at time t₂ by the decay between states |d> and |p>.

2. The method of claim 1, wherein the atom is Rb.

3. The method of claim 2, wherein the atom is ⁸⁷Rb and
$$\vert 0 >= \vert 5 {s}_{\frac{1}{2}} ,$$
f=1, m=1>,
$$\vert 1 >= \vert 5 {s}_{\frac{1}{2}} ,$$
f=2, m=2>,
$$\vert d >= \vert 4 {d}_{\frac{5}{2}} ,$$
f=4, m=4>, and
$$\vert p >= \vert 5 {p}_{\frac{3}{2}} ,$$
f=3, m=3>, or wherein the atom is ⁸⁵Rb and
$$\vert 0 >= \vert 5 {s}_{\frac{1}{2}} ,$$
f=2, m=2>,
$$\vert 1 >= \vert 5 {s}_{\frac{1}{2}} ,$$
f=3, m=3>,
$$\vert d >= \vert 4 {d}_{\frac{5}{2}} ,$$
f=5, m=5>, and
$$\vert p >= \vert 5 {p}_{\frac{3}{2}} ,$$
f=4, m=4>.

4. The method of claim 1, wherein the telecom wavelength photon is a 1529 nm photon.

5. The method of claim 1, wherein the atom is coupled to an optical resonator and the method further comprises collecting and transmitting the time-bin encoded telecom wavelength photon along an optical transmission line.

6. A method for generating a polarization encoded telecom wavelength photon, the method comprising:
(a) preparing a superposition state in an atom in a trap, wherein the superposition state is |v/>=(|0>+|1>)/\sqrt{2};
(b) exciting state |1> to an excited state |d₁> and state |0> to an excited state |d₀>, wherein the excited state |d₁>decays along path |d₁>→|p_{1 >→|}1> and the excited state |d₀>decays along path |d₀>→|p₀>→|0> to a decay state of the atom and the telecom wavelength photon |Ψ>=(|0>|σ₋>+|1 >|σ₊>)/\sqrt{2} where |σ_> and |σ₊>represent telecom wavelength photon generated by the decay between states |d₀> and |p₀> and |d₁> and |p 1>, respectively.

7. The method of claim 6, wherein the atom is Rb.

8. The method of claim 7,
wherein the atom is ⁸⁷Rb and
$$\vert 0 >= \vert 5 {s}_{\frac{1}{2}} ,$$
f=2, m=−2>,
$$\vert 1 >= \vert 5 {s}_{\frac{1}{2}} ,$$
f=2, m=2>,
$$\vert {d}_{0} >= \vert 4 {ds}_{\frac{5}{2}} ,$$
f=4, m=−4>,
$$\vert {p}_{0} >= \vert 5 {p}_{\frac{3}{2}} ,$$
f=3, m=−3>,
$$\vert {d}_{1} >= \vert 4 {d}_{\frac{5}{2}} ,$$
f=4, m=4>, and
$$\vert {p}_{1} >= \vert 5 {p}_{\frac{3}{2}} ,$$
f=3, m=−3>, or wherein the atom is ⁸⁵Rb and
$$\vert 0 >= \vert 5 {s}_{\frac{1}{2}} ,$$
f=3, m=−3>,
$$\vert 1 >= \vert 5 {s}_{\frac{1}{2}} ,$$
f=3, m=3>,
$$\vert {d}_{0} >= \vert 4 {d}_{\frac{5}{2}} ,$$
f=5, m=−5>,
$$\vert {p}_{0} >= \vert 5 {p}_{\frac{3}{2}} ,$$
f=4, m=−4>,
$$\vert {d}_{1} >= \vert 4 {d}_{\frac{5}{2}} ,$$
f=5, m=5>, and
$$\vert {p}_{1} >= \vert 5 {p}_{\frac{3}{2}} ,$$
f=4, m=4>.

9. The method of claim 6, wherein the telecom wavelength photon is a 1529 nm photon.

10. The method of claim 6, wherein the atom is coupled to an optical resonator and the method further comprises collecting and transmitting the time-bin encoded telecom wavelength photon along an optical transmission line.

11. A method for entangling an atom and a photon, the method comprising:
(a) applying a first polarized light pulse to the atom in state |1 [symbol] to couple state |1 [symbol] to a first excited state |p [symbol] ,
(b) applying a polarized telecom wavelength photon have an opposite polarization to the first polarized light pulse to cause the transition of the first exited state |p [symbol] to a second excited state |d [symbol] ,
(c) applying a second polarized light pulse having the same polarization as the first polarized light pulse to couple the second excited state |d [symbol] to a ground state |0 [symbol] .

12. The method of claim 11, wherein the atom is Rb.

13. The method of claim 11, wherein the atom is ⁸⁷Rb and
$$\vert 0 >= \vert 5 {s}_{\frac{1}{2}} ,$$
f=1, m=1>,
$$\vert 1 >= \vert 5 {s}_{\frac{1}{2}} ,$$
f=2, m=2>,
$$\vert d >= \vert 4 {d}_{\frac{5}{2}} ,$$
f=4, m=4>, and
$$\vert p >= \vert 5 {p}_{\frac{3}{2}} ,$$
f=3, m=3>, or wherein the atom is 85Rb and
$$\vert 0 >= \vert 5 {s}_{\frac{1}{2}} ,$$
f=2, m=2>,
$$\vert 1 >= \vert 5 {s}_{\frac{1}{2}} ,$$
f=3, m=3>,
$$\vert d >= \vert 4 {d}_{\frac{5}{2}} ,$$
f=5, m=5>, and
$$\vert p >= \vert 5 {p}_{\frac{3}{2}} ,$$
f=4, m=4>.

14. The method of claim 11, wherein the telecom wavelength photon is detuned from a resonant transition frequency to prevent spontaneously decay.

15. A system for remote entanglement, the system comprising:
a first end station comprising a first matter qubit and a second end station comprising a second matter qubit; and
a Bell measurement apparatus optically connected to the first end station and the second end station,
wherein each of the first end station and second end station entangle the matter qubit and a telecom wavelength photon generated by the method according to claim 1,
wherein the telecom wavelength photon is transmitted to the Bell measurement apparatus, and
wherein the Bell measurement apparatus projects the first matter qubit at the first end station and the second matter qubit at the second end station into an entangled state.

16. The system of claim 15, wherein the first end station and the second end station are optically connected by a chain of intermediate entanglement sources and Bell state measurement units.

17. A system for remote entanglement, the system comprising:
a first end station comprising a first matter qubit and a second end station comprising a second matter qubit; and
a Bell measurement apparatus optically connected to the first end station and the second end station,
wherein each of the first end station and second end station entangle the matter qubit and a telecom wavelength photon generated by the method according to claim 6,
wherein the telecom wavelength photon is transmitted to the Bell measurement apparatus, and
wherein the Bell measurement apparatus projects the first matter qubit at the first end station and the second matter qubit at the second end station into an entangled state.

18. The system of claim 17, wherein the first end station and the second end station are optically connected by a chain of intermediate entanglement sources and Bell state measurement units.

19. A system for remote entanglement, the system comprising:
a first end station comprising a first matter qubit; and
a second end station comprising a second matter qubit;
wherein the first end station is optically connected to the second end station,
wherein the first matter qubit is entangled with a telecom photon generated by the method according to claim 1 that is transmitted to coherently interact with the second matter qubit; and
wherein the first matter qubit and second matter qubit become entangled.

20. A system for remote entanglement, the system comprising:
a first end station comprising a first matter qubit; and
a second end station comprising a second matter qubit;
wherein the first end station is optically connected to the second end station,
wherein the first matter qubit is entangled with a telecom photon generated by the method according to claim 6 that is transmitted to coherently interact with the second matter qubit; and
wherein the first matter qubit and second matter qubit become entangled.
